(19) United States
(12) Patent Application Publication
(10) Pub. No.: US 2026/0211000 A1
(43) Pub. Date: Jul. 23, 2026

(54) Sample Holder and Measurement Method for Scanning Tunneling Microscopy

(71) Applicant: National Taiwan University, Taipei (TW)

(72) Inventors: Ya-Ping Chiu, Taipei (TW); Bo-Chao Huang, Taipei (TW); Zi-Liang Yang, Taipei (TW)

(21) Appl. No.: 19/028,717

(22) Filed: Jan. 17, 2025

(51) Int. Cl. G01Q 30/20; G01Q 30/16; G01Q 60/12

(52) U.S. Cl. CPC G01Q 30/20; G01Q 30/16; G01Q 60/12

(57) ABSTRACT

A multifunctional sample holder for conducting in-situ cross-sectional scanning tunneling microscopy measurements under ultra-high vacuum (UHV) is provided. This sample holder is designed for use in UHV and at low temperatures. It comprises an insulating plate made of a vacuum-compatible polymer (for example, PCTFE) and a conductive plate made of a highly conductive metal (for example, gold-plated beryllium copper). A sample-fixing assembly ensures that the sample remains stably upright during in-situ cleaving, thus exposing a fresh cross section for atomic-scale imaging. The sample holder includes electrical contact elements for applying bias voltage and injecting current, and it features functional elements such as heating elements, temperature sensors, or magnetic field components arranged on or inside the sample holder. These features make it possible to perform cross-sectional scanning tunneling microscopy measurements under controlled voltage, temperature, and magnetic field conditions simultaneously, enabling comprehensive atomic-level analysis of semiconductor devices and other advanced materials.

### FIELD OF THE DISCLOSURE

The present invention generally relates to sample holders for scanning probe microscopy. More specifically, the invention relates to an improved sample holder for cross-sectional scanning tunneling microscopy that enables in-situ regulation of a sample by way of bias voltage, temperature control, and/or a magnetic field under ultra-high vacuum (UHV) conditions. The invention is particularly suitable for performing atomic-level characterization of advanced semiconductor devices.

### BACKGROUND OF THE INVENTION

Scanning tunneling microscopy (STM) is widely used to observe and measure the surface topography and electronic structure of materials with atomic resolution. Conventional STM sample holders typically support measurements of only a single surface and operate under static conditions, potentially lacking the ability to apply bias voltages, temperature variations, or magnetic fields simultaneously. Although various commercial STM sample holders exist on the market, they are often designed to perform only one specialized function—whether cross-sectional cleaving, temperature control, or magnetic field application—and thus cannot carry out multifunctional, integrated testing of semiconductor devices.

In addition, cross-sectional studies of electronic devices using STM are extremely important for understanding layered structures, heterojunction interfaces, and active regions. However, existing holders often cannot effectively perform in-situ cleaving of the sample, expose a fresh cross section, and simultaneously apply operating conditions (such as bias voltage or temperature changes) to simulate actual device functionalities. This shortfall can hinder comprehensive characterization of next-generation electronic devices, especially when analyzing nanoscale materials and semiconductor structures that exhibit temperature-and voltage-dependent behaviors.

Thus, there is a need for a multifunctional, UHV-compatible sample holder capable of supporting cross-sectional cleaving, maintaining alignment after cleaving, and simultaneously applying external controls—namely voltage, temperature, and magnetic field—during STM measurements. The present invention meets this need and provides additional advantages.

### SUMMARY OF THE INVENTION

In view of the foregoing and other objectives, the present invention provides a multifunctional sample holder designed for in-situ cross-sectional scanning tunneling microscopy measurements under ultra-high vacuum conditions. The sample holder includes a base module that has at least one insulating plate and at least one conductive plate. The insulating plate is made of a vacuum-compatible polymer such as polychlorotrifluoroethylene (PCTFE) or polyether ether ketone (PEEK), and the conductive plate is made of a highly conductive metal, for example gold-plated beryllium copper. A sample-fixing assembly grips the sample in an upright orientation, allowing for in-situ cleaving along a pre-scored line and providing direct access to the newly exposed cross section for atomic-scale measurements.

The sample holder contains multiple electrical contact elements that extend from the exterior to the interior of the holder, allowing bias voltage application or current injection into the sample's electrodes. In addition, functional elements such as a resistive heating element, a temperature sensor, and/or a magnetic field generator (for instance, an electromagnet) are arranged on or within the base module. By integrating these components into the sample holder, the present invention facilitates in-situ measurement of the cross-sectional electronic properties of the sample under different operating conditions—including variations in voltage, temperature, and magnetic field—thus providing a multifunctional measurement platform.

Accordingly, the present invention makes it possible to study and analyze advanced devices such as semiconductor heterostructures, junctions, and nanoscale interfaces. This enhanced functionality far exceeds that of conventional single-purpose sample holders, offering greater experimental versatility and more accurate insights into device behavior at the atomic level.

To make the above features and advantages of the present invention more apparent and understandable, a preferred embodiment is exemplified below, in conjunction with the accompanying drawings, for detailed description.

### BRIEF DESCRIPTION OF THE DRAWINGS

Below, the present invention and its differences from conventional technology will be described based on the drawings and various embodiments. The drawings are provided for illustrative purposes only, not to limit the scope in any way, wherein similar reference numerals refer to similar components, and in which:

FIG. 1 is a perspective schematic view of an embodiment of the sample holder according to the present invention.

FIG. 2 is an exploded view of the components of the sample holder according to the present invention.

FIG. 3 is a schematic view showing a sample after cleaving in an embodiment of the present invention.

FIG. 4 is a schematic view showing how a small resistor is connected in an embodiment of the present invention.

FIG. 5 is a schematic view showing a magnetic field component attached to the base module in an embodiment of the present invention.

FIG. 6 is a flowchart illustrating a method of conducting in-situ cross-sectional scanning tunneling microscopy measurements on a sample under ultra-high vacuum conditions according to the present invention.

### DESCRIPTION OF THE PREFERRED EMBODIMENTS

The present invention relates to a multifunctional sample holder designed for in-situ cross-sectional scanning tunneling microscopy (STM) measurements under ultra-high vacuum (UHV) conditions and, optionally, at low temperatures. This sample holder integrates the simultaneous application of bias voltage, temperature control, and a magnetic field, while keeping a newly exposed cross section of the sample stably positioned. By incorporating these functionalities, the invention overcomes limitations of conventional STM sample holders, which typically perform only one function, such as basic cross-sectional mounting or temperature control, thereby restricting comprehensive device characterization.

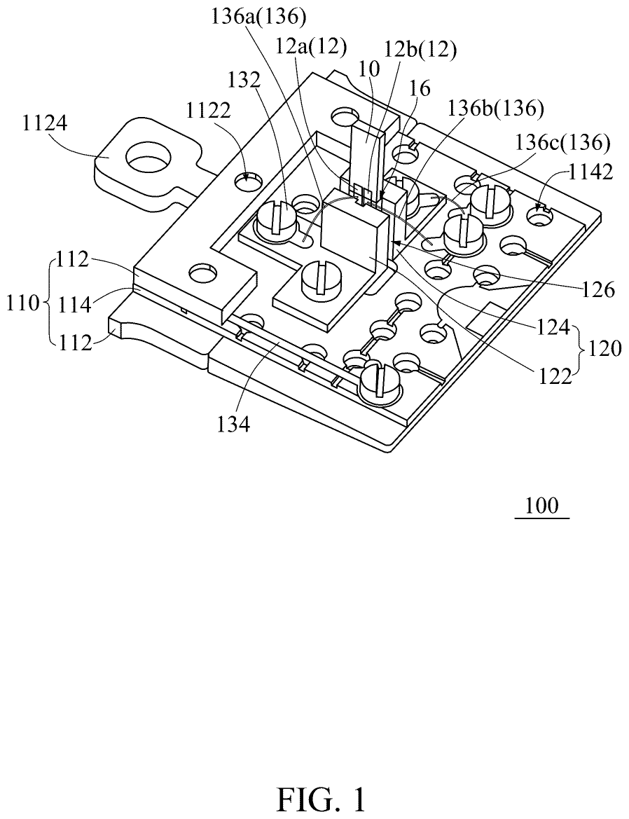

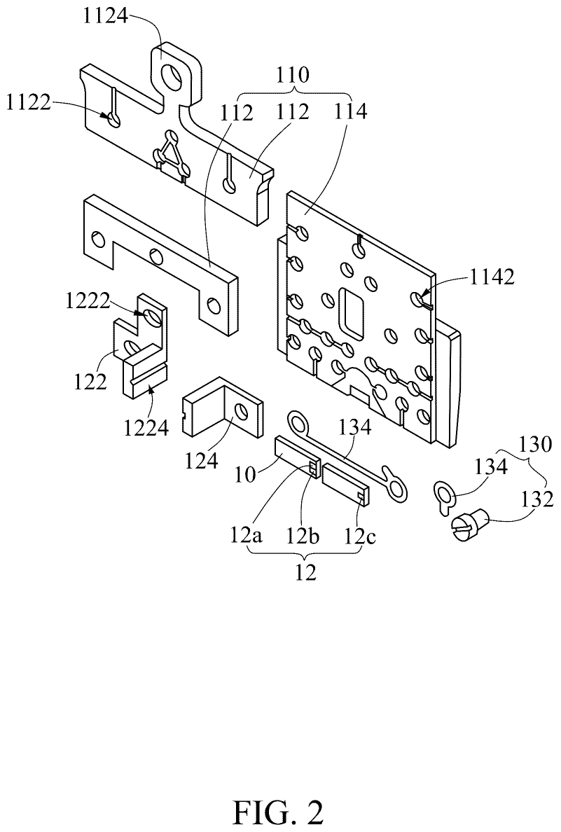

Referring to FIG. 1 and FIG. 2, FIG. 1 shows a perspective schematic view of an embodiment of the sample holder 100 according to the present invention, and FIG. 2 shows an exploded view of the sample holder's components. In this embodiment, the sample holder 100 includes a base module 110 composed of at least one conductive plate 112 made of a conductive material (two conductive plates 112 are used in this embodiment) and at least one insulating plate 114 made of an insulating material. These layers are stacked to form a structurally rigid and UHV-compatible platform. In general, the conductive plate 112 is made of a highly conductive metal; in this embodiment it is gold-plated beryllium copper, which is chosen for its corrosion resistance and low outgassing in vacuum. The insulating plate 114, located adjacent to the conductive plate 112, may be formed from polychlorotrifluoroethylene (PCTFE) or polyether ether ketone (PEEK) to isolate current paths and prevent unwanted short circuits. These polymer materials are also selected for their dimensional stability at low temperatures and chemical inertness under UHV conditions. In variants requiring higher mechanical strength, anodized aluminum may be used instead of or in combination with the insulating plate or structural layers. The sample holder 100 is assembled using screws 132 or low-outgassing adhesives (for instance, Torr Seal from Agilent Technologies) to ensure tight sealing and stable operation at both room and low temperatures. In this embodiment, multiple threaded holes 1122, 1142 are formed in the conductive plate 112 and insulating plate 114, respectively, to accommodate the screws 132. By running screws 132 through these holes 1122, 1142, the conductive plates 112 and insulating plate 114 are fastened together. Additionally, one of the conductive plates 112 is provided with a pull-ring 1124 to facilitate gripping by a mechanical arm (not shown).

Mounted on this base module 110 is a sample-fixing assembly 120 designed to hold a sample 10 in a vertical orientation, both during and after the cleaving process. In this embodiment, the sample-fixing assembly 120 comprises two components, namely a clamping component 122 and a fastener 124. Both are made of a rigid, vacuum-compatible material such as anodized aluminum. The clamping component 122 is designed with a clamping face 1224 that can move or adjust relative to the fastener 124 to grip the sample 10. In this embodiment, threaded holes 1222 in the clamping component 122 are enlarged to allow for movement and adjustment. The fastener 124 is more permanently secured to the insulating plate 114 of the sample holder 110. Together, the clamping component 122 and fastener 124 define a clamping space 126 into which the sample 10 can be inserted in an upright orientation.

During assembly, one or more screws 132 pass through appropriately sized holes in the clamping component 122, pulling the clamping component 122 toward the fastener 124 and pressing the sample 10 firmly into place. In certain designs, the threaded screws 132 pass through threaded holes 123 on the sample-fixing assembly 120 and through the insulating plate 114 on the base module 110, thereby securing the sample-fixing assembly 120 to the base module 110.

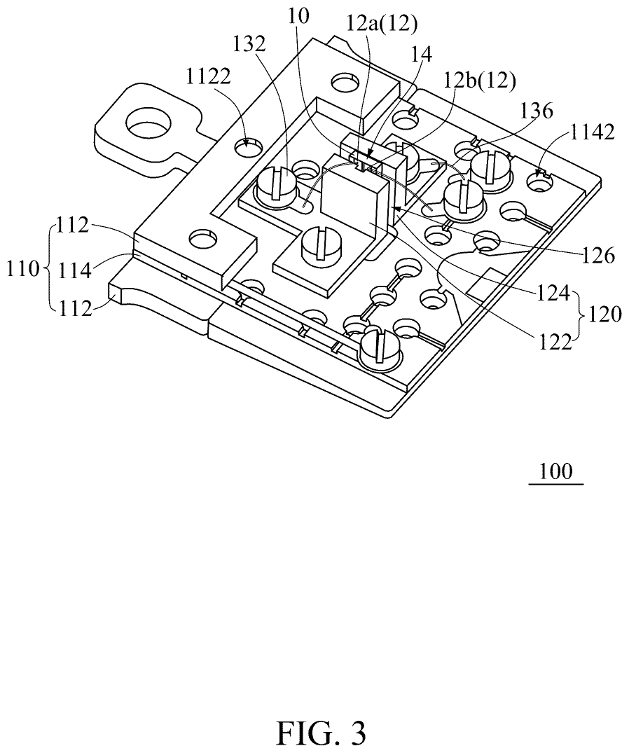

Before cleaving, as shown in FIG. 1, the sample 10 generally has a pre-scored region 16 for cleaving. Next, a mechanical or robotic arm (not shown, for example, a wobble stick) applies force along the score 12, causing the sample 10 to split along the pre-formed notch 12 and expose a newly created cross section 14 suitable for atomic-scale inspection (see FIG. 3). Throughout the process, the sample-fixing assembly 120 prevents shifting or vibration of the sample 10, keeping the newly exposed cross section 14 in place. After the cleaving is complete, the invention allows the STM tip to approach from above the layers previously located within the interior of sample 10, thereby enabling researchers to study heterojunctions, layered semiconductor stacks, or other advanced materials'structure and electronic properties.

In this embodiment, the sample holder 100 also includes multiple electrical contact elements 130, allowing direct application of bias voltage or current to different parts of the sample. These electrical contact elements 130 typically comprise screws 132 of good conductivity, conductive paths 134, and wires 136. They pass through the insulating plate 114 to provide connection points for external instruments (not shown). By connecting lab equipment such as current sources, voltage drivers, or lock-in amplifiers, users can monitor and manipulate the electronic states of the sample 10 in real time. In this embodiment, the sample holder 100 relies on the existing interference mitigation measures of a standard STM system, meaning that the sample holder 100 need not incorporate specialized shielding grooves or cable channels unless required. In this embodiment, for example, the STM system may be an INFINITY SPM Lab, TRIBUS SPMLT STM Lab, POLAR SPM Lab, Infinity SPM Lab, Tribus SPM, LT NANOPROBE Lab, or STREAM SPM Lab from Scienta Omicron.

In this embodiment, the conductive paths 134 are thin metal foils of low-outgassing, high-conductivity material (such as copper) laid flat on the insulating plate 114 of the sample holder 100. Each conductive path 134 has openings through which screws 132 can pass for fastening. Additionally, in this embodiment, wires 136 directly connect the sample electrodes 12 on the sample 10 to the screws 132. More specifically, wires labeled 136a, 136b, and 136c connect the source electrode 12a, drain electrode 12b, and bottom electrode 12c of the sample 10, respectively, to corresponding screws 132, which are passed through the insulating plate 114 of the sample holder 100.

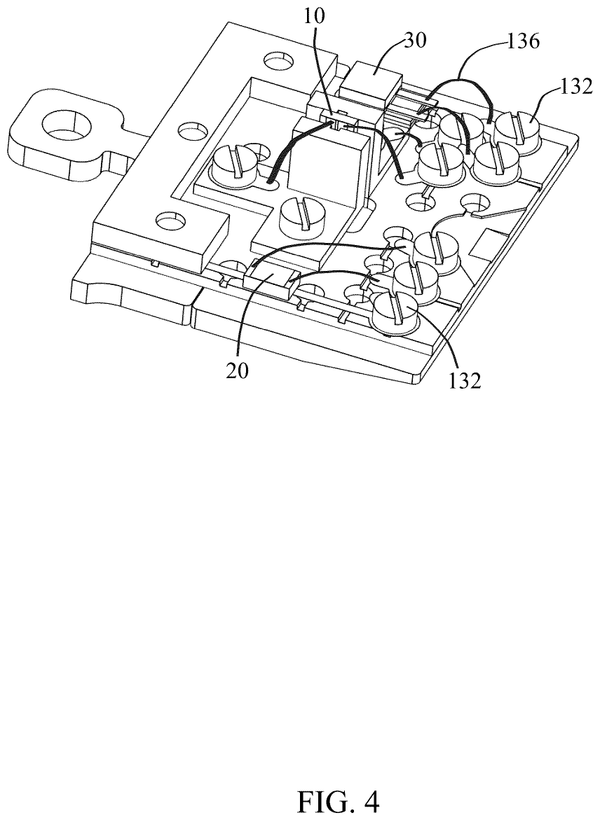

Regarding temperature regulation, as shown in FIG. 4, a small resistor 20 or other heating element can be installed on the sample holder 100. This small resistor 20 is electrically connected to the screws 132 and the conductive paths 134 and wires 136. When current flows through the small resistor 20, it generates heat. Because the conductive paths 134 and wires 136 installed on the sample holder 100 possess excellent thermal conductivity, the heat generated by the small resistor 20 can be transferred to the sample 10, allowing its temperature to be raised from low to moderate or higher levels as needed. Furthermore, in FIG. 4, a temperature sensor 30 (such as a thermocouple) may be secured to the base module 110. The temperature sensor 30 is likewise electrically connected through the wires 136 and the screws 132 and conductive paths 134. Because the small resistor 20, sample 10, and temperature sensor 30 lie in the same circuit, the sensor 30 can provide accurate real-time temperature feedback as the sample 10 is heated by the resistor 20. Such an arrangement is especially important for experiments investigating how electronic or structural properties evolve with temperature—a critical factor in semiconductor device development and fundamental materials research. In FIG. 4, adhesives such as Torr Seal may be used to secure the small resistor 20 and temperature sensor 30 to the base module 110. Note that some of the screws 132 on the sample holder 100 are electrically connected to contact points in the STM itself, thereby enabling electrical connection with external instruments (not shown).

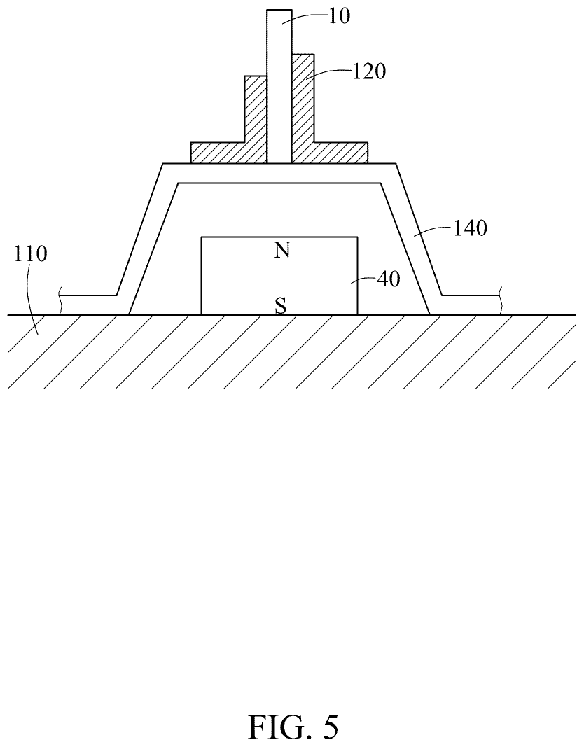

In another embodiment, referring also to FIG. 5, a magnetic field component 40, such as an electromagnet or permanent magnet, can be installed on the base module 110. In one implementation, a bridging support structure 140 on the base module 110 elevates the sample 10 and the sample-fixing assembly 120, providing sufficient clearance 116 to accommodate the magnetic field component 40. If the magnetic field component 40 is an electromagnet, researchers can modulate the current to vary the magnetic field, thereby studying spin-dependent phenomena, magnetoresistive effects, or other experiments relevant to advanced electronic and spintronic devices. Alternatively, if dynamic variation is not required, the magnetic field component 40 can be a permanent magnet to provide a constant magnetic field.

The materials selected for the present invention aim to minimize contamination in UHV environments and maintain stable mechanical and electrical properties at temperatures below 10 K. Polymers like PCTFE or PEEK exhibit low outgassing and preserve dimensional stability even at low temperatures, while gold-plated beryllium copper offers excellent conductivity and corrosion resistance. Any adhesive used must also be low-outgassing to maintain vacuum quality. These choices enable the sample holder 100 to be used in STM systems capable of reaching extremely low pressures, facilitating high-resolution atomic-scale imaging.

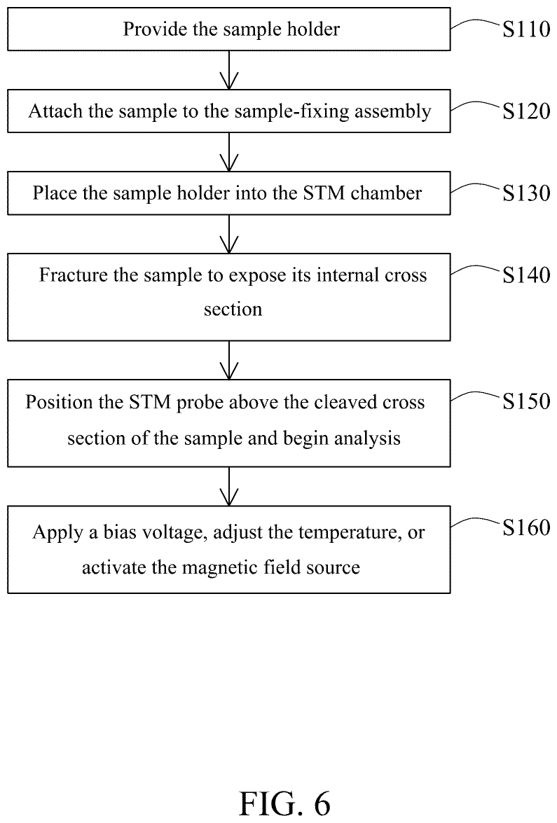

Referring next to FIG. 6, FIG. 6 illustrates a flowchart of a method for performing in-situ cross-sectional scanning tunneling microscopy measurements on a sample under UHV conditions according to the present invention. In this embodiment, the procedure typically follows simple steps for in-situ cross-sectional STM under UHV. First (Step S110), the sample holder 100 described above is provided. Next (Step S120), the user attaches the sample 10 to the sample-fixing assembly 120, ensuring that the sample 10 has a pre-scored notch in the region to be cleaved. Then (Step S130), after the sample holder 100 is placed into the STM chamber, the environment is pumped down to ultra-high vacuum, and low-temperature cooling can be applied if required by the experiment. Next (Step S140), a cleaving step is performed by applying force along the score, causing the sample 10 to fracture and exposing the internal cross section, all while the sample 10 remains mounted in the sample holder 100 in an upright position. Afterward, in Step S150, the researcher positions the STM tip above the newly exposed cross section of the cleaved sample 10 to begin imaging or spectroscopy analysis. Simultaneously, Step S160 includes the application of bias voltage, temperature changes, or magnetic field activation. This measurement method supports the concurrent application of various physical conditions, distinguishing the present invention from existing sample holders that cannot easily integrate these functionalities without significant modifications.

Although the primary embodiment features a layered base, a simple clamping system, and a resistor-based heating mechanism, alternative or additional functions may be incorporated. For example, the sample-fixing assembly can be replaced by a micrometer-driven mechanism to achieve precise tensile adjustment, or the heating element may be replaced with a thin-film resistor deposited on the sample holder surface. The quantity and arrangement of screws can also be modified to accommodate more complex device terminals or to mount multiple samples on a single sample holder. Likewise, modular functional units can be introduced to support alternative measurement methods or specialized instrumentation (including advanced magnetic coils or sensor arrays).

In summary, the above-described multifunctional sample holder facilitates in-situ cross-sectional scanning tunneling microscopy measurements under ultra-high vacuum, with previously unavailable functionalities for bias control, thermal regulation, and the potential application of magnetic fields. By creating a stable, low-outgassing, and temperature-tolerant platform to support upright sample cleaving and real-time measurements, the present invention greatly expands the range of device research that can be carried out in STM systems under UHV conditions. Its flexible, modular nature ensures that researchers can adapt the holder to various experimental needs and thereby gain deeper insights into the physical properties and performance of next-generation electronic, optoelectronic, and spintronic materials. All such variations and modifications are considered within the scope of the present invention as described in the appended claims.

1. A multifunctional sample holder for performing in-situ cross-sectional scanning tunneling microscopy measurements under ultra-high vacuum conditions, the sample holder being configured to operate under ultra-high vacuum and comprising:
a base module comprising at least one insulating plate made of a vacuum-compatible polymer and at least one conductive plate made of a highly conductive metal, the insulating plate and the conductive plate being fastened together to form a single support structure;
a sample-fixing assembly mounted on the base module, the sample-fixing assembly comprising at least one clamping component and at least one fastener, wherein the sample-fixing assembly is adapted to position and hold a sample in an upright orientation so that, upon in-situ cleaving, the sample's cross section is exposed;
a plurality of electrical contact elements extending from the outer surface to an interior portion of the base module, the electrical contact elements being arranged to connect with at least one electrode on the sample so as to apply a bias voltage or inject current into the sample; and
at least one functional element disposed on or within the base module, selected from the group consisting of a heating element, a temperature sensor, and a magnetic field generating element.

2. The sample holder of claim 1, further comprising an adhesive for bonding the functional element to the base module, wherein the adhesive is a low-outgassing epoxy resin.

3. The sample holder of claim 1, wherein the vacuum-compatible polymer is selected from the group consisting of polychlorotrifluoroethylene (PCTFE) and polyether ether ketone (PEEK).

4. The sample holder of claim 1, wherein the highly conductive metal comprises gold-plated beryllium copper.

5. The sample holder of claim 1, wherein the sample-fixing assembly is made of anodized aluminum.

6. The sample holder of claim 1, wherein the electrical contact elements comprise threaded screws passing through the insulating plate, each of the screws being configured to connect to an external power source or measuring instrument so as to facilitate applying a bias or injecting signals into the sample.

7. The sample holder of claim 1, further comprising a resistor-based heating element electrically connected to at least one of the electrical contact elements, the heating element being configured to generate localized heat to vary the sample's temperature within a chosen range during scanning tunneling microscopy measurements.

8. The sample holder of claim 7, wherein at least one temperature sensor is attached to the base module by a vacuum-compatible adhesive, and the temperature sensor is positioned to directly monitor the temperature of the sample or the region surrounding the sample.

9. The sample holder of claim 1, wherein the base module further comprises a bridging support structure that creates a clearance space between the sample and the surface of the base module for accommodating the magnetic field generating element.

10. A method for performing in-situ cross-sectional scanning tunneling microscopy measurements on a sample under ultra-high vacuum conditions, the method comprising:
providing a multifunctional sample holder configured to operate under ultra-high vacuum, the sample holder including:
a base module having at least one insulating plate made of a vacuum-compatible polymer and at least one conductive plate made of a highly conductive metal, the insulating plate and the conductive plate being fastened together to form a single support structure;
a sample-fixing assembly mounted on the base module, the sample-fixing assembly comprising at least one clamping component and at least one fastener, wherein the sample-fixing assembly is adapted to position and hold a sample in an upright orientation so that, upon in-situ cleaving, the sample's cross section is exposed;
a plurality of electrical contact elements extending from the outer surface to an interior portion of the base module, the electrical contact elements being arranged to connect with at least one electrode on the sample so as to apply a bias voltage or inject current into the sample; and
at least one functional element disposed on or within the base module, selected from the group consisting of a heating element, a temperature sensor, and a magnetic field generating element;
mounting a sample in an upright orientation onto the sample-fixing assembly of the sample holder, the sample having a pre-scored notch in the region to be cleaved;
placing the sample holder into a vacuum chamber and evacuating the chamber to ultra-high vacuum conditions;
cleaving the sample along the pre-scored notch to expose a new cross section of the sample while keeping the sample mounted in the sample holder;
applying at least one of a bias voltage, a variable temperature, or a magnetic field to the sample; and
positioning the tip of a scanning tunneling microscope above the newly cleaved cross section of the sample to perform atomic-scale measurements.

11. The method of claim 10, further comprising bonding the functional element to the base module of the sample holder with a low-outgassing epoxy resin.

12. The method of claim 10, wherein the vacuum-compatible polymer of the insulating plate is selected from the group consisting of polychlorotrifluoroethylene (PCTFE) and polyether ether ketone (PEEK).

13. The method of claim 10, wherein the highly conductive metal of the conductive plate is gold-plated beryllium copper.

14. The method of claim 10, wherein the sample-fixing assembly of the sample holder is made of anodized aluminum.

15. The method of claim 10, wherein the electrical contact elements of the sample holder comprise threaded screws passing through the insulating plate, each screw being configured to connect to an external power source or measuring instrument so as to facilitate applying a bias or injecting signals into the sample.

16. The method of claim 10, further comprising electrically connecting a resistor-based heating element to at least one of the electrical contact elements of the sample holder, the heating element being configured to generate localized heat to vary the sample's temperature within a chosen range during scanning tunneling microscopy measurements.

17. The method of claim 16, further comprising attaching at least one temperature sensor to the base module with a vacuum-compatible adhesive so as to directly monitor the temperature of the sample or the region surrounding the sample.

18. The method of claim 10, wherein the base module of the sample holder further comprises a bridging support structure that creates a clearance space between the sample and the surface of the base module for accommodating the magnetic field generating element.
